(19) United States
(12) Patent Application Publication
(10) Pub. No.: US 2019/0301668 A1
(43) Pub. Date: Oct. 3, 2019

(54) DEVICE FOR QUICK MANUAL MOUNTING AND DISMOUNTING OF EQUIPMENT ON TOP SURFACE OF WALL

(71) Applicant: Yangjun MAI, Huizhou (CN)

(72) Inventor: Yangjun MAI, Huizhou (CN)

(21) Appl. No.: 15/984,320

(22) Filed: May 19, 2018

(30) Foreign Application Priority Data
Apr. 3, 2018 (CN) 201810287817.X
Apr. 3, 2018 (CN) 2018204615337.1

(51) Int. Cl. F16M 13/02; F16B 2/18; H04R 1/02; F24F 13/32

(52) U.S. Cl. CPC F16M 13/02; F16B 2/185; F21V 21/088; F24F 13/32; H04R 1/026

(57) ABSTRACT

The invention discloses a device designed for the quick manual mounting and dismounting of equipment on the top surface of a wall, comprising: a surface frame, a climber, a connecting rod, a first spring, a bracket, a pushrod, a knob, a second spring and a stop lever. Wherein, a support board used for mounting holes is installed between the surface frame and climber, the surface frame and bracket are connected, the pushrod and the first spring are connected, the first spring is placed inside the bracket, the connecting rod and the pushrod are connected, the climber is installed on the front end of the connecting rod, the knob and the stop lever are connected, and the second spring is installed on the stop lever.

### TECHNICAL FIELD

The invention relates to mounting devices, more specifically to a device for quick mounting and dismounting of equipment on the top surface of a wall such as decorative lighting, exhaust fans and ceiling speakers through rotating inner frame.

### BACKGROUND ART

At present, such mounting usually uses screws or springs, which is quite inconvenient. The quick mounting and dismounting structure with unique rotating inner frame designed according to mechanics and mechanical principles only needs holes reserved and the mounting can be done quickly by placing the product into the rotating inner frame. The product also can be dismounted quickly with the rotating inner frame, thus saving both time and labor.

### SUMMARY OF THE INVENTION

Present invention is designed to provide a device for quick mounting and dismounting of equipment on the top surface of a wall such as decorative lighting, exhaust fans and ceiling speakers through rotating inner frame in order to solve the above-mentioned problem in the Background Art.

Present invention adopts the following technical solution to the above-mentioned technical problem:

A device designed for the quick manual mounting and dismounting of equipment on the top surface of a wall, comprising: a surface frame (1), a climber (2), a connecting rod (3), a first spring (4), a bracket (5), a pushrod (6), a knob (7), a second spring (8) and a stop lever (9). Wherein, a support board (10) used for mounting holes is installed between the surface frame (1) and climber (2), the surface frame (1) and bracket (5) are connected, the pushrod (6) and the first spring (4) are connected, the first spring (4) is placed inside the bracket (5), the connecting rod (3) and the pushrod (6) are connected, the climber (2) is installed on the front end of the connecting rod (3), the knob (7) and the stop lever (9) are connected, and the second spring (8) is installed on the stop lever (9).

Preferably, the rotating knob drives the stop lever, the climber clamps the support board down with the action of spring by virtue of the connecting rod, and the protruding teeth on the back of climber and the protruding teeth on the stud of the surface frame engage to fix the product on the mounting plate.

Preferably, the wall equipment refers to decorative lighting, ceiling speakers or exhaust fans.

Compared with the prior art, the beneficial effect of present invention is that equipment can be quickly mounted with excellent results.

Other features and benefits of present invention will be described in the description below, while some will be obvious in the description or understood by embodiments of the present invention. The purposes and other benefits of present invention can be realized and obtained through structures specifically indicated in the description, claims, and attached drawings.

### DESCRIPTION OF THE DRAWINGS

Present invention is described in detail with the attached drawings to further define and clarify the benefits. Wherein:

FIG. 1 is a structure diagram of the device designed for the quick manual mounting and dismounting of equipment on the top surface of a wall;

FIG. 2 is a structure diagram of the device designed for the quick manual mounting and dismounting of equipment on the top surface of a wall;

FIG. 3 is a structure diagram of the device designed for the quick manual mounting and dismounting of equipment on the top surface of a wall;

FIG. 4 is a structure diagram of the device designed for the quick manual mounting and dismounting of equipment on the top surface of a wall;

FIG. 5 is a structure diagram of the device designed for the quick manual mounting and dismounting of equipment on the top surface of a wall;

FIG. 6 is a structure diagram of the device designed for the quick manual mounting and dismounting of equipment on the top surface of a wall.

### DESCRIPTION OF THE EMBODIMENTS

Implementations of the present invention are described below in detail taken with the drawings and embodiments, so as to fully understand and implement the process that the present invention employs technical means to solve the technical problems and achieve the technical effects. It should be noted that each embodiment of the present invention and each feature in each embodiment can be combined as long as no conflict is caused. All technical schemes formed are included in the scope of protection of the present invention.

As shown in FIGS. 1-6, a device designed for quick manual mounting and dismounting of equipment on the top surface of a wall, comprising: a surface frame (1), a climber (2), a connecting rod (3), a first spring (4), a bracket (5), a pushrod (6), a knob (7), a second spring (8) and a stop lever (9). Wherein, a support board (10) used for mounting holes is installed between the surface frame (1) and climber (2), the surface frame (1) and bracket (5) are connected, the pushrod (6) and the first spring (4) are connected, the first spring (4) is placed inside the bracket (5), the connecting rod (3) and the pushrod (6) are connected, the climber (2) is installed on the front end of the connecting rod (3), the knob (7) and the stop lever (9) are connected, and the second spring (8) is installed on the stop lever (9).

Preferably, the rotating knob drives the stop lever, the climber clamps the support board down with the action of spring by virtue of the connecting rod, and the protruding teeth on the back of climber and the protruding teeth on the stud of the surface frame engage to fix the product on the mounting plate.

Preferably, the wall equipment refers to decorative lighting, ceiling speakers or exhaust fans.

The working principle of the present invention is as follows:

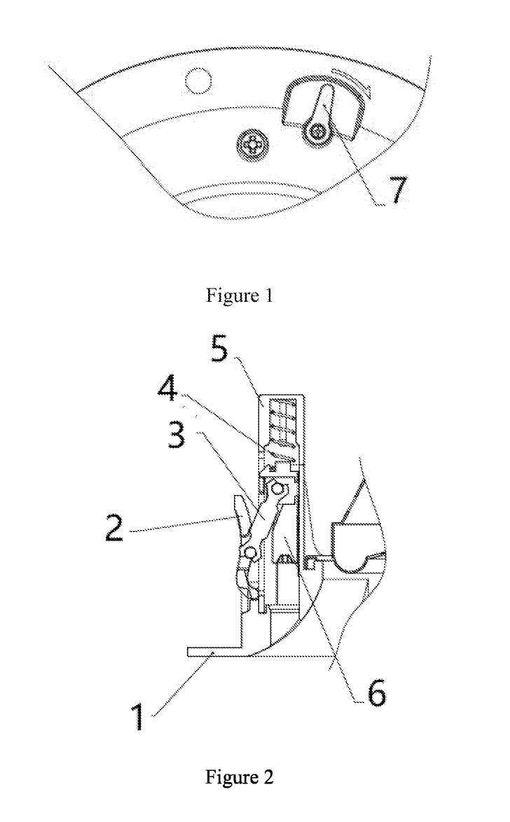

The stop lever (9) in initial position stops the positioning bump of the connecting rod (3). As shown in FIGS. 1 and 2, the rotating knob (7) drives the stop lever (9) and the stop lever opens to release the connecting rod. The first spring (4) causes the connecting rod (3) to push down the climber (2). The protruding teeth on the back of climber (2) and the protruding teeth on the stud of the surface frame (1) engage to fix the product on the support board. The stop lever (9) is reset by the second spring (8).

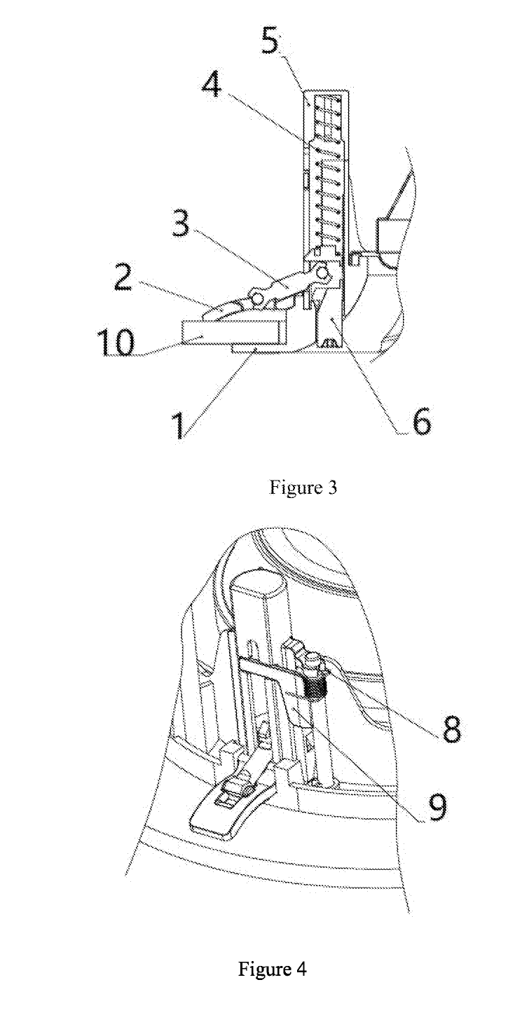

As shown in FIGS. 3 and 4, the pushrod (6) is pushed by a screwdriver in the dismounting process, the climber (2) is driven upwards by the connecting rod (3), the positioning bump of the connecting rod (3) is secured by the stop lever (9) and reset to the original position, and then the product is dismounted.

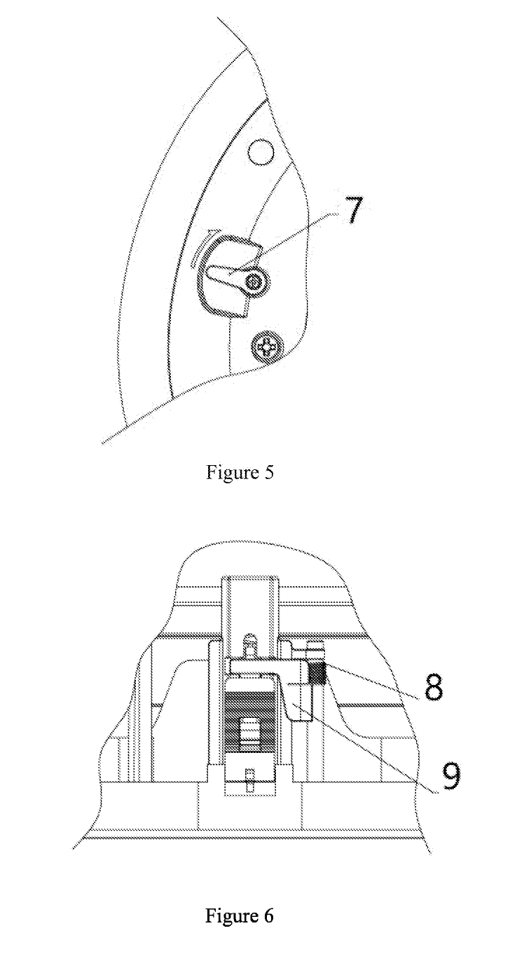

As shown in FIGS. 5 and 6, the product should be held with hands during dismounting to prevent it from falling down.

Above is a detailed description for the preferred embodiments of the present patent; however, the present patent is not limited to the above embodiments. Within the scope of knowledge of general technicians of companies in this field, variations can be made within the purpose of the present patent.

Finally, it should be noted that above are preferred embodiments of the present invention and are not intended to limit the present invention; although the present invention has been described in detail by reference to these embodiments, technicians in this field still can modify the technical schemes recorded in each embodiment mentioned above or substitute some of the technical features equivalently. Any modifications, equivalent substitutions and improvements made within the spirit and principle of the present invention shall be included in the scope of protection of the present invention.

1. A device designed for quick manual mounting and dismounting of equipment on the top surface of a wall, comprising:
a surface frame (1),
a climber (2),
a connecting rod (3),
a first spring (4),
a bracket (5),
a pushrod (6),
a knob (7),
a second spring (8), and
a stop lever (9);
wherein,
a support board (10) is between the surface frame (1) and the climber (2),
the surface frame (1) and the bracket (5) are connected,
the pushrod (6) and the first spring (4) are connected,
the first spring (4) is placed inside the bracket (5),
the connecting rod (3) and the pushrod (6) are connected,
the climber (2) is installed on the front end of the connecting rod (3),
the knob (7) and the stop lever (9) are connected, and
the second spring (8) is installed on the stop lever (9).

2. The quick mounting and dismounting device of claim 1, wherein the knob is configured to rotate to drive the stop lever, the climber is configured to clamp the support board down with a spring by virtue of the connecting rod, and a first set of protruding teeth on a back of the climber and a second set of protruding teeth on a stud of the surface frame are configured to engage to fix the equipment on a mounting plate.

3. (canceled)
